(19) United States
(12) Patent Application Publication
(10) Pub. No.: US 2008/0221935 A1
(43) Pub. Date: Sep. 11, 2008

(54) SYSTEM FOR INDIVIDUAL RETRAINING ASSOCIATED WITH A JOB LOSS

(76) Inventor: J. Randall Beckers, Rockville, MD (US)

Correspondence Address: STAAS & HALSEY LLP, SUITE 700, 1201 NEW YORK AVENUE, N.W., WASHINGTON, DC, 20005, US

(21) Appl. No.: 12/044,376

(22) Filed: Mar. 7, 2008

Related U.S. Application Data
(60) Provisional application No. 60/893,747, filed on Mar. 8, 2007.
(60) Provisional application No. 61/023,283, filed on Jan. 24, 2008.

(51) Int. Cl. G06Q 40/00; G06Q 20/00

(52) U.S. Cl. 705/4; 705/39; 705/36 R

(57) ABSTRACT

The system described herein allows an individual or worker who has a job to select a different occupation to be trained for in the event of a job loss. The information about the new occupation, such as cost of education, books, etc. along with the cost of living during the retraining and subsequent job search and the probability of job loss are used to determine a periodic payment for such retraining. This payment is made while the individual works. When the individuals loses the job, the individual is provided with living expenses, occupation retraining and job location assistance.

### CROSS-REFERENCE TO RELATED APPLICATION(S)

This application is related to U.S. provisional application entitled A System For Individual Retraining Associated With A Job Loss having Ser. No. 60/893,747, by Beckers, filed Mar. 8, 2007 and incorporated by reference herein. This application is related to U.S. provisional application entitled A System For Individual Retraining Associated With A Job Loss having Ser. No. 61/023,283, by Beckers, filed Jan. 24, 2008 and incorporated by reference herein.

### BACKGROUND

1. Field

The present disclosure is directed to a system for retraining a worker when a job loss occurs.

2. Description of the Related Art

Today, workers in many fields may lose their jobs because of changes in technology, consolidation of industry, transfer of work overseas, or other economic dislocation events that are not based on worker performance. In such situations, a worker may be dismissed (fired—reduction in force) or otherwise lose or are laid off from their job. If the worker is trained in an outmoded job, it may be very difficult for the worker to obtain a job in a different field. Additionally, the period of layoff may be so long that the individual may need to look for another job. During the period in which the worker looks for a new job, the worker can get a limited amount of financial assistance, such as state provided unemployment insurance and welfare. If the worker wants to be trained for a new job, it is typically the responsibility of the worker to pay for the retraining.

What is needed is a system that will allow a worker to receive economic assistance and retraining that can be controlled by the worker when a job is lost because of a non-cause related job loss or a loss that is not related to job performance (or not performance-related).

### BRIEF DESCRIPTION OF THE DRAWINGS

FIG. 1 depicts operations associated with obtaining a contract for job retraining.

FIG. 2 illustrates operations associated with retraining and obtaining a new occupation.

FIG. 3 depicts a system.

FIG. 4 depicts databases.

FIG. 5 shows a display used in the system

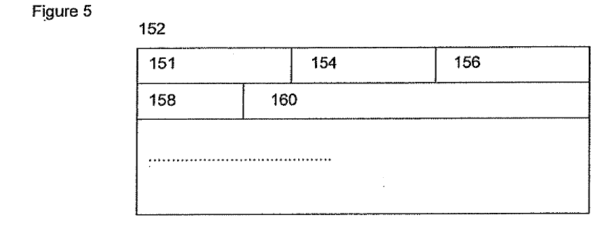

FIG. 6 parts of an insurance contract.

### DETAILED DESCRIPTION OF THE EMBODIMENTS

It is an aspect of the present embodiments to provide a system that will allow a worker to receive economic assistance and retraining controlled by the worker when a job is lost because of a non performance-related job loss where the job loss is not related to the workers performance and is not for cause.

The above aspect can be attained by a system that allows the individual or worker to select retraining to be provided when the worker loses a job and a periodic payment (or premium) is determined for a benefit that covers or includes the retraining, living expenses (wages/salary, medical insurance, etc.) during retraining and/or a job hunt that can be after retraining. When the individuals loses the job, the individual is provided with living expenses, occupation retraining and job location assistance.

These together with other aspects and advantages that will be subsequently apparent, reside in the details of construction and operation as more fully hereinafter described and claimed herein, reference being had to the accompanying drawings forming a part hereof, wherein like numerals refer to like parts throughout.

When a worker loses a job because of a reason unrelated to performance or a non-cause reason, the system discussed herein provides a worker with the economic ability to maintain a desired standard of living, to be retrained in a desired field and to obtain assistance in obtaining a job in a desired field.

The above can be accomplished by a system that allows workers to purchase a benefit that pays for job or task retraining and living assistance. This assistance would essentially provide a worker with living expenses while the worker is being retrained (including medical insurance comparable to current insurance), pay for retraining in a job that the worker selects (possibly with the assistance of a job counselor), provide living assistance while and in getting a job in the new field and with assistance in getting the job after being retrained. In this system an actuary determines the risk of a job loss based on job loss statistics and other information for the industry of the worker. The actuary takes into account that only a fraction of all workers who have such coverage will ever file a claim. From the education market and the workers current education, the cost of and time required for training in a desired field is determined. Current income (wages/salary), adjusted for inflation, can be used to determine living expenses. From the job market, the time likely needed to obtain a job in the desired new field, after being retrained, can also be determined. With this information, the size of a periodic payment (such as monthly or per paycheck) needed for this type of assistance benefit can be determined.

A worker would apply for this assistance by providing information such as current job, current earnings (or expected living expenses), level of current education and desired job for which the person would want to be retrained. The system would calculate the payment needed. If the worker felt that the payment was unaffordable, the worker could select a different desired new job. This payment determination with worker feedback could go on until the worker found a “new” job that could be afforded.

The jobs or tasks that people would want to be retrained for would probably be limited by what the person thought they could do based on their experience and education as well as by the size of the payments needed to buy the assistance. For example, a data entry clerk would probably not want to be retrained as a medical doctor. But the clerk might want to be retrained as a medical office assistant.

When a job is lost because of one of the task competition reasons (not for cause, such as bad performance), the system could confirm the basis for the job loss, begin paying a living allowance, assist in finding an appropriate educational facility, pay for the tuition as the bills are submitted or in toto, check to make sure that passing grades are being obtained, and when the retraining is completed, assist the worker in finding a job. Of course, many of the operations discussed herein could be subcontracted to companies that specialize in what is needed. For example, job counseling to determine an appropriate new job as well as assistance in finding a new job could be handled by a job counseling company.

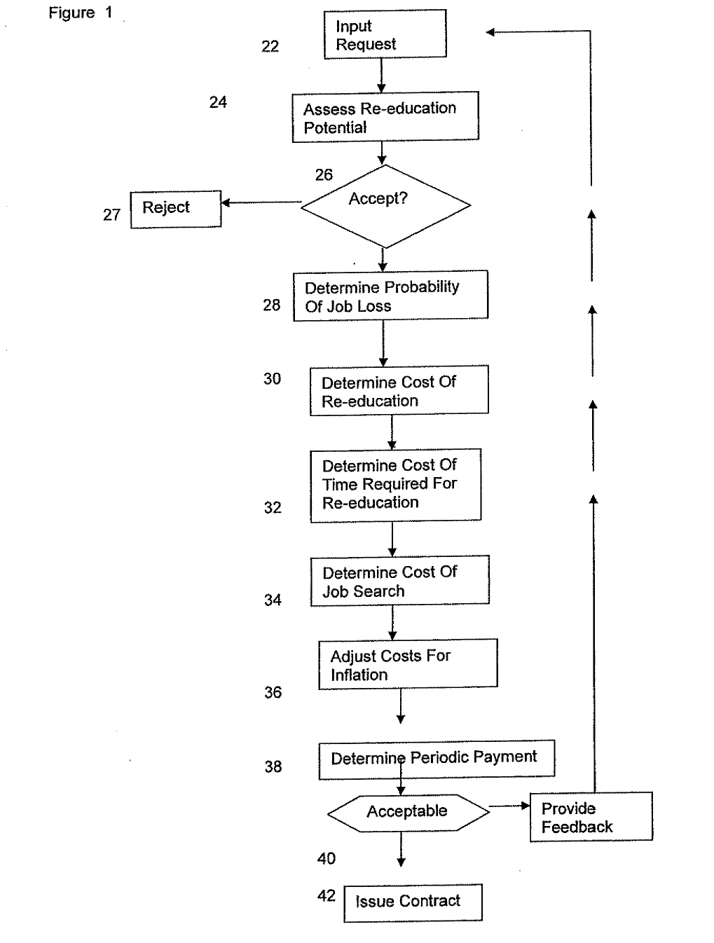

As depicted in FIG. 1, an individual (worker) provides 22 a request for coverage providing, for example, age, sex, residence address, current occupation, length of employment, current earnings, current medical insurance provider and level of insurance coverage, current education level, desired retraining occupation, desired retraining facility, etc. Current earnings can be before or after tax earnings, the individual's actual or estimated living expenses, inclusive of family expenses, such as education expenses, or an amount of money set by the individual based on the individual's particular circumstances. Additional information, such as job history, education history, such as school transcripts, alternate retraining occupations, etc. can also be provided. For example, the worker might be 25 years of age, be a shipping clerk in the automobile parts industry making $20,000 a year, be covered by a basic type medical coverage, have a high school education and may want to be retrained as a data entry clerk in the medical industry. The request is stored in a database for retraining contracts.

The system assesses 24 the re-education potential of the worker. This can be done automatically or by a jobs retraining specialist. This assessment by a specialist could compare the current education and current occupation with the desired occupation and the education needed for the desired occupation. When automated, this operation can involve accessing a training/education database to obtain the minimum educational requirement for an occupation, such as the data entry clerk example where it is assumed that a data entry clerk education requires a minimum of a high school education. The required education is then compared to the education level of the worker. The likelihood of this worker being able to attain the education needed for the job is determined. This can be a yes/no or a numerical rating with conditions, such as minimum educational level required for the new occupation and/or any remedial training that may be needed (and an estimate of the cost for such remedial training if such is to be paid by the worker). In this example, since the worker has the minimum required education, the assessment is positive.

Next, the system determines 26 whether the request for assistance should be accepted. That is, if the assessment is positive, the request is positive. If not accepted, the application can be rejected 27. The rejection can provide reasons for the rejection, such as the individual does not have the basic skills to start a training/retraining program for the occupation requested. This rejection may also suggest retraining occupations for which the individual is suited.

If the retraining potential is acceptable, the probability of job loss is determined 28 using the information provided by the individual as well as historical job loss data, such as found in various surveys and statistical compilations, such as the Displaced Worker Supplement to the Current Population Survey produced by the U.S. government, which can be provided in a jobs statistics database. For example, assume that the probability of job loss for a worker in the automobile parts industry at age 25 is 3% (0.03)

The cost of the re-education for the retraining can then be determined 30. This can involve the specialist finding a suitable facility and obtaining the cost information. If this operation is automated, the education database is accessed with the new occupation information to obtain the cost and an educational facility name and location closest to the workers residence. For the example being discussed herein, assume that the requirements for education for a data entry clerk with a high school education include a three-month course that costs $10,000 in books and tuition and where the course starts quarterly and that a facility is within 10 miles of the workers residence. This cost is stored the request database.

The time/cost required for the retraining can be determined 32. In example, the being discussed, the times required for retraining is the three months associated with the course and the three months that may be required for the worker to wait to start the course. The cost of living during training is determined, in the current example, as 6 months/12 months*$20,000=$10,000. The cost of medical insurance or care during the period also needs to be determined. In this case, a cost of medical coverage is the cost of continuation coverage of the workers policy, since the time required for the retraining is less than the continuation coverage period of 18 months. Assume this cost is $100 month more than the worker was paying at the shipping clerk job, resulting in a cost of 6*100=$600. If the continuation coverage would expire before retraining can be completed, the cost of medical coverage equivalent to the current basic coverage currently would need to be determined. These costs are totaled (=$10,600) and stored in a request database.

An estimate of the time required for a job search upon completion of retraining is determined 34. This information can be estimated by the specialist or be automated. To automatically determine the time required for obtaining a job in the data entry field in the region of the workers residence, the unemployment statistics for the region for this type of job can be obtained from a jobs database. Assume that the time required to obtain a job is six weeks (1.5 months). From this information, the cost of living during the time it takes to obtain a job is estimated as 1.5 months/12 months*$20,000=$2,500. Medical coverage cost is also determined as 1.5*100−$150. These costs are totaled ($2,650) and stored in the request database.

The costs can then be adjusted 36 for inflation and other factors based on the job loss probability and stored in the database.

Next, using the above information, the system determines 38 a periodic payment amount using the costs, probability of job loss, actuarial tables, loss models, stochastic methods, financial theory, etc. In this case the total cost for which the payment is determined is $10,000+$10,600+$2,650=$23,250. This determination can be made automatically or by a professional actuary. Conventional approaches to determining this periodic payment can be used, such as described by Joseph M. Belth in association with insurance premium calculations as described in Calculation of Life Insurance Gross Premiums: A Suggested Modification of the Traditional Textbook Approach, by Joseph M. Belth, The Journal of Risk and Insurance, Vol. 34, No. 3 (September, 1967), pp. 385-396.

The periodic payment amount or premium can be stored in the contracts database.

The periodic payment amount is presented to the individual requesting the displacement/retraining assistance and the individual decides 40 whether the periodic payment is affordable. If so, a contract is issued 42 and the contract information is stored in the database. The individual also begins making the periodic payments. If the payments are not affordable, feedback 44 can be given to the individual, such as suggestions for alternate retraining occupations that will reduce the periodic payments.

The periodic payment can be obtained directly from the individual by the individual paying the periodic payment. Or the periodic payment can be automatically paid by the individual via a deduction form the individuals periodic earnings by the employer and the employer making the payment. The amount of the periodic payment can be updated as the circumstances or retraining goals of the individual change. For example, once a year the individual could be asked to update the information used to determine the periodic payment, such as current earnings, current education or on the job training/experience, the desired new occupation, etc. This updated information can be used to recalculate or determine the periodic payment. This updated information also provides the system with updated information concerning the amount of money that needs to be available to payout to or provide to the individual for the retraining, living expense, etc. The employer could also provide updated information, such as current earnings, occupations, etc.

The system monitors for the periodic payments and issues bills and notices as needed. The periodic payments or premiums are accumulated and invested to provide funds for making payments under the contract when an individual loses their job.

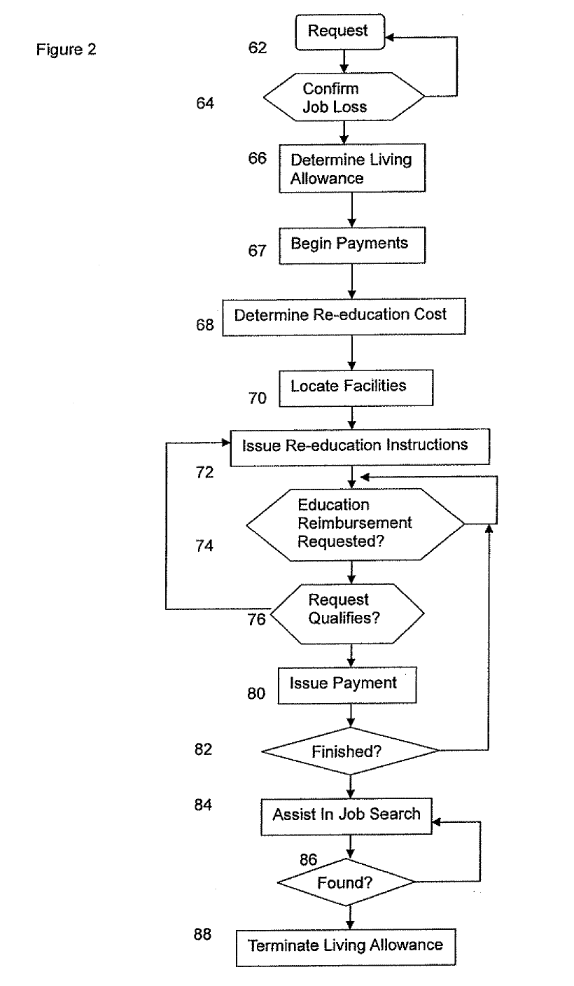

When an individual with an assistance contract makes a request 62 for retraining based on a job loss, the system stores the request in a claims database and determines 64 whether the request is based on a job loss of the type specified in the contract as depicted in FIG. 2. The request includes information on the current earnings, basis for job loss, current residence, current education, etc. The request can also include information from the individual as to preferences, such as when there is more than one training facility for a particular occupation near the residence of the individual and the individual has a preference. For example, this confirmation of type of job loss or determination 64 could include checking with the employer to confirm whether the job loss was because of a layoff or some other reason, such as whether the individual has resigned from the job.

Based on the request, the system determines 66 living expenses and begins 67 making payments to the worker and stores the information in the claims database. This can be accomplished by accessing the database for the most recent current earnings (as periodically updated) and adjusting the earnings for inflation, if needed.

The system also assesses 68 the retraining cost based on current education costs for the retraining needed, location of retraining facility, current education, etc. and locates 70 appropriate education facilities where the reeducation can be obtained. Again this can be determined by accessing the most recent or updated information in the database. This information is also stored in the database.

The living, retraining, etc. costs can also be adjusted by any benefits that the employee gets from other sources of money such as unemployment insurance benefits, education grants, training grants, job grants or other insurance.

The system then issues 72 retraining or reeducation instructions that are also stored in the database. These instructions identify the facility designated for the retraining, the cost of courses, books, expected completion schedule, etc. The individual proceeds to enroll in the facility and presents 74 a request for reimbursement. The system determines 76 whether the request qualifies for reimbursement. That is, the system determines whether the request matches the information of the instructions, such as a specified course at a specified facility. If so, a payment is issued 80 to the individual to reimburse the individual for the education cost and the database is updated.

It is also possible for the system to issue a payment in part or in toto directly to the educational institution rather than have the worker seek reimbursement.

The system then waits for another reimbursement request or for an indication 78 that the retraining is finished 82. Of course the payments could be made automatically until the amount or cost of the retraining is paid.

If the retraining is finished, the individual is assisted 84 with a job search, as needed. This may be automated, such as providing the individual job information from the jobs database, or may be provided by a jobs counselor or a combination.

When a job is found 86, the living allowance is terminated 88 and the claims database is updated.

The individual can then update the information concerning the occupation of the newly obtained job, current earnings, desired retraining occupation, etc. and a new periodic payment can be started.

As an alternative to the calculation and payment of living expenses and retraining, the assistance with finding a retraining facility, assisting in finding a job, etc. as discussed above, the system could determine these costs, obtain a present value for the costs and offer the individual a lump sum payment. The individual would then be responsible for obtaining the retraining, paying living expenses, finding a new occupation, etc.

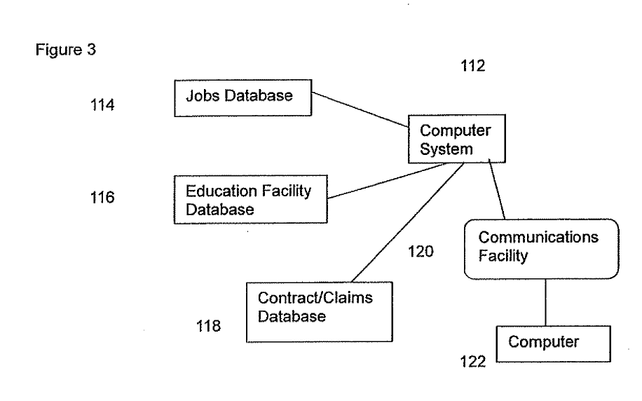

FIG. 3 depicts the hardware in which the system may be incorporated. A computer system 112 is coupled to a jobs database 114, an education facility database 116 and a contract/claims database 118. The databases can be combined into a single database. The system can also be connected to an individual (or the employer) via a communications 120 facility, such as the Internet, and a computer 122, such as the individual's personal computer, allowing the individual to apply for retraining coverage and receive information about coverage, etc. via the computer 122. A computer, like 122, can also be used to allow an evaluator, such one that would determine whether the individual could be retrained for the desired occupation from the individual's background (education, job skills, etc.), to perform an evaluation as well as to allow a job counselor to help an individual find a job after retraining.

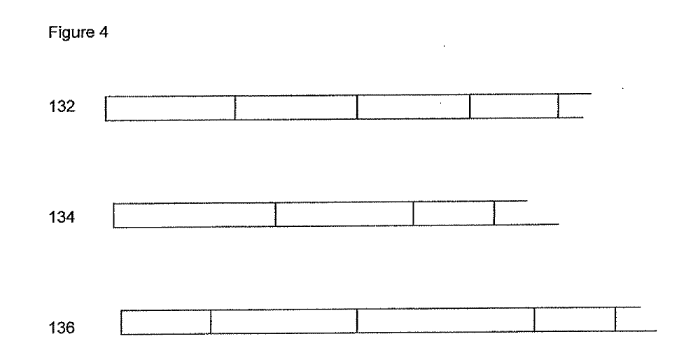

FIG. 4 illustrates records of the databases of FIG. 3. Jobs database records 132 can include fields for job type or occupation, education requirement, job loss probability, job statistics, such as time required to find a job, unemployment information, etc. An education facility database includes records 134 with fields for occupation, such as packing engineer, course requirements, course costs, course facility location, course start dates, minimum required education for entry, etc. A record 136 for a contract/claim database includes fields for name, age, residence address, occupation, current earnings, education level, medical coverage, desired retraining, facility, expected cost of living, expected costs of training, expected costs of job hunt, probability of job loss, contract payments, etc. associated with determining whether to and issuing a contract as well as records for current cost of living, current costs of training, expected training time, payments, etc. associated with requests for retraining.

The computer 122 used by the individual or someone helping the individual applying for retraining can be presented with a display 152, by computer 112, which will allow the individual to provide the information needed. This display 152 can include fields for entering name 151, current earnings 154, occupation 156 selected for retraining, desired retraining facility 158, and other information discussed above. When the system determines the periodic payment, the periodic payment amount can also be presented in field 160 as well as other information, such as feedback about alternate retraining. The display 152 can also be used for providing the periodic updates. The information provided by the system computer 122 during the retraining and job search can also be provided by this display 152. Additionally, any information, such as a chat with a counselor, can also be conducted via the display.

The above-discussed operations and system could be provided by an insurance company (and subcontractors) determining a premium, administering claims, etc. or even by a private educational institution or some other organization.

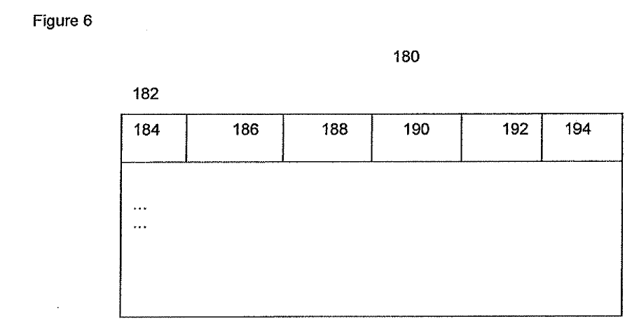

In such a situation, the method and system can be embodied in an insurance contract. The insurance contract is a contract whereby the insurance company will pay the worker or provide the assistance, if the events described above, such as a job loss due to the movement of a job out of the country, occur. The insurance company draws up the contract and the worker typically has little ability to make material changes to it other than specifying the retraining to be covered. The insurance company makes a legally enforceable promise in the contract. The insurance contract requires both parties of the insurance contact to deal in good faith, such as the employee cannot collude with the employer to be laid off “because of a job transfer to another country” when in fact the employee is fired for cause and, in particular, it imparts on the insured a duty to disclose all material facts which relate to the risk to be covered, such as the actual reason for a job loss. The worker is required to pay the premiums and if they are not paid the policy lapses. The insurance company is required to pay or provide the benefits under the contract if the insured has paid the premiums and met the basic provisions. The parts of the insurance contract are typically recorded in a database (see FIG. 6) of the insurance company and embodied in a written agreement provided to the worker that includes the provisions of the database. The database 180 can include records 182 with fields that store the information of the parts of the contract. The parts can include definitions 184 that define important terms used in the policy language, for example, the definitions can define a loss based on a transfer of the job out of the country to possibly mean a job loss for which the employer does not offer the worker substitute employment at a commensurate remuneration or one in which the employee is laid off the job because of the transfer. The contract has an insuring agreement 186 that can describe the covered perils, such as loss of job due to transfer of job out of the country, risks assumed, nature of coverage, such as payment for retraining for a chosen new job, can make reference to the contractual agreement between insurance company and the worker and can summarizes the promises of the insurance company, as well as stating what is covered. The declarations 188 identify who is an insured, the insured's address, the insuring company, what risks are covered, the policy limits (amount of insurance), any applicable deductibles, such as any unemployment insurance payments to the worker or severance payments from the company, the policy period and premium amount. Exclusions 190 take coverage away from the insuring agreement by losses arising from specific causes which are not covered by the policy, for example, extra costs not directly associated with the job loss such as the loss of use of a previously purchased clothes required to the lost job like work boots may not be covered. The parts of the contract also include conditions 192 which are provisions, rules of conduct, duties and obligations required for coverage. If policy conditions are not met, the insurer can deny the claim. A contract identifier 194, such as an alphanumeric identifier, can also be included in the record 182.

An industrial or service company in an industry that has task competition among its jobs, or which has job layoffs, could offer (and even subsidize) this type of insurance. Potential employees might be more likely to come to work for such a company. Or like life, long-term disability, car and home insurance, special agents could handle this type of insurance. The benefit could be subsidized in whole or in part by an employer and one or more government agencies. If subsidized by the employer, the contract could be portable with the individual making the entire periodic payment in the event of a change in employer by the individual.

The government could provide assistance in the form of a tax deduction/credit for the insurance premium or even overlapping subsidies from different levels of government such as state and federal governments.

Any government provided assistance or sources of funds, such as retraining grants by a state or federal agency unemployment payments by a state government, welfare payments, etc can be integrated into the payment made to the individual during the retraining and hunt for a new job.

Such a system would engrain retraining into a free market system in a way that allows workers free choice.

The system described herein has been discussed with respect to providing a worker with the workers choice of retraining when a job is lost because of task competition. However, the system can also allow a worker to receive economic assistance and retraining controlled by the worker when a job is lost because of a reason not related to job performance, such as company downsizing, a layoff or an economic problem, such as a recession. The worker has more freedom of choice. Of course, in another embodiment at the time the worker loses a job, the system can allow the worker to choose to be retrained for a different occupation than previously selected and as needed, the worker may be more or less benefits, depending on the retraining cost of the old and new selection.

The system also described herein need not have the worker designate a retraining job or field but can be targeted at a specific coverage amount that will cover lost wages, etc. and costs associated for retraining, finding work, etc.

Even though the system has been described as having the worker make a periodic payment for the coverage, it is possible for the worker to make a lump sum payment that will cover a desired retraining, living expenses, job hunt period of time, etc. In addition, since the cost of the retraining, living expenses, job hunt, is relatively fixed, except of inflation and cost of living type changes, it is also possible to terminate the premium payments after a specific amount has been paid, and thus create a paid-up benefit.

The system, in another embodiment, can also allow the worker to determine how much money is needed for their retraining, living expenses etc. without designating a particular type of retraining and receive a lump sum payment when the job is lost. In addition, in another embodiment, monthly benefit payments to the worker, based on living expenses, retraining posts, etc., who loses a job can be made as long as the worker is being retrained, looking for a job, etc.

The system can also be set-up to choose a retraining for a worker.

The system also includes permanent or removable storage, such as magnetic and optical discs, RAM, ROM, etc. on which the processes, displays and data structures of the present invention can be stored and distributed. The processes, etc. can also be distributed via, for example, downloading over a network, such as the Internet, or over a transmission medium.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus, comprising:
a system determining a periodic payment by a working individual for the working individual to receive occupation retraining and living expenses in the event of a job loss and providing the individual with funds for occupation retraining and living expenses in the event of the job loss

2. A computer readable storage for controlling a computer and storing a process comprising determining a periodic payment for a working individual to receive occupation retraining and living expenses in the event of a job loss and providing the individual with funds for occupation retraining and living expenses in the event of the job loss.

3. A database for determining a periodic payment for a working individual to receive occupation retraining and living expenses in the event of a job loss and providing the individual with funds for occupation retraining and living expenses in the event of the job loss, comprising:
a field for cost of retraining for an occupation;
a field for cost of living during retraining; and
a field for a periodic payment for the cost of retraining and living.

4. A method, comprising:
obtaining information from an individual who desires to receive occupation retraining and living expenses in the event of a job loss; and
determining a periodic payment for the individual to receive the occupation retraining and the living expenses in the event of the job loss.

5. A method, comprising:
receiving a request for occupation retraining and living expenses from an individual who has made periodic payments to receive the occupation retraining and the living expenses in the event of a job loss; and
providing the individual with funds for occupation retraining and living expenses in the event of the job loss.

6. A method, comprising:
determining a periodic payment for a working individual to make to receive occupation retraining and living expenses in the event of a job loss; and
providing the individual with funds for occupation retraining and living expenses in the event of the job loss.

7. A method as recited in claim 6, wherein the determining comprises:
determining a probability of job loss for the individual; and
determining the periodic payment using the job loss probability, current earnings and cost of retraining.

8. A method as recited in claim 7, wherein the determining of the periodic payment comprises determining living expenses for a retraining period and a job search period.

9. A method as recited in claim 8, wherein the determining of the living expenses comprises determining a cost of medical insurance.

10. A method as recited in claim 6, wherein the providing comprises providing the user with a single payment covering living expenses and retraining cost for a retraining period and a job search period

11. A method as recited in claim 6, wherein the providing comprises:
confirming whether the job loss qualifies; and
making payments for living expenses and retraining.

12. A method as recited in claim 11, wherein the making comprises:
making periodic living expense payments during an unemployed period;
determining a retraining cost; and
paying for qualified retraining costs.

13. A method as recited in claim 12, wherein the making further comprises:
locating a retraining facility;
monitoring progress of the retraining; and
assisting the individual in finding a job after retraining is completed.

14. A method as recited in claim 6, further comprises:
updating occupation retraining and living expenses; and
determining a periodic payment responsive to the updating.

15. A method as recited in claim 6, wherein the individual selects the occupation retraining.

16. A method as recited in claim 15, wherein the selection is prior to beginning of the periodic payment.

17. A method as recited in claim 6, wherein the job loss is for other than cause.

18. A display, comprising:
a first field for designating an occupation for retraining upon of a job loss; and
a second field for designating living expenses upon the job loss.

19. A display as recited in claim 15, further comprising a field for displaying a periodic payment determined using a job loss probability, living expenses current earnings and cost of retraining for the occupation.

20. A contract, comprising a contract identifier, definitions; an insuring agreement describing job loss coverage for a job lost for reasons other than cause and for retraining for a chosen replacement job; declarations identifying a worker whose job may be lost, identifying the chosen replacement job, a coverage amount and a premium.

21. A computer readable storage for controlling a computer, comprising:
a contract identifier field;
a definitions field;
an insuring agreement field describing job loss coverage for a job being moved out of a country and for retraining for an insured chosen replacement job;
a declarations field identifying a worker whose job may be lost, identifying the chosen replacement job, a coverage amount and a premium;
an exclusions field excluding coverage for job loss for cause; and
a conditions field.

22. A method, comprising:
receiving a request for replacement wages expenses from an individual who has made periodic payments to receive the replacement wages in the event of a job loss; and
providing the individual with replacement wages in the event of the job loss.

23. A method as recited in claim 22, further comprising receiving a request for living expenses and providing funds for living expenses.
